(19) United States
(12) Patent Application Publication
(10) Pub. No.: US 2008/0203701 A1
(43) Pub. Date: Aug. 28, 2008

(54) Custom motorcycle air suspension parking stand

(76) Inventor: Alfred Daniel Adams, Oak Hills, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/012,103

(22) Filed: Jan. 31, 2008

Related U.S. Application Data
(60) Provisional application No. 60/891,305, filed on Feb. 23, 2007.

(51) Int. Cl. B62H 1/02

(52) U.S. Cl. 280/302

(57) ABSTRACT

Improvements in a motorcycle kick stand are disclosed. The kick stand works with the air suspension of a motorcycle or with a mechanical jack or solenoid. The kick stand uses legs or a bar that are rotated by the rider under the motorcycle. When the air suspension is vented the motorcycle lowers onto the kick stand. In other embodiments the kick stand is rotated by the user and powered down to ground to support the motorcycle.

### CROSS REFERENCE TO RELATED APPLICATION

This application claims the benefit of Provisional 60/891,305 filed Feb. 23, 2007 the entire contents of which is hereby expressly incorporated by reference herein.

### DESCRIPTION

1. Field of the Invention

This invention relates to improvements to a motorcycle parking stand. More particularly, the present motorcycle parking stand is a pair of supporting legs that are rotated by the rider and the air suspension system of the motorcycle is vented and the motorcycle lowers onto the parking stand.

2. Background of the Invention

Most motorcycle stands exist on one side of a motorcycle. When the user is done ridding they extend the kick stand out one side of the motorcycle and lean the motorcycle to the side of the kickstand to rest the motorcycle on two wheels and the kickstand. While this is the typical method used with most motorcycles the side kickstand has several problems. The greatest problem is when the kickstand sinks into dirt or asphalt surface and the motorcycle falls over causing damage to a motorcycle. Several inventions have been patented to retain a parked motorcycle in an upright orientation to eliminate this problem. Exemplary examples are discloses herein.

U.S. Pat. No. 6,679,054 issued Jan. 20, 2004 to Marco Doveri and U.S. Pat. No. 7,140,631 issued Nov. 28, 2006 to Clay K. Ridley both disclose a side kickstand that is powered from a retracted to an extended configuration. While these kickstands provide the convenience of allowing a user to press a button to raise or lower the kickstand these kick stands only provide support at one side of the motorcycle and still allow the motorcycle to lean to one side.

Some motorcycle stands both form a stand and a lifting mechanism where one wheel is lifted off the ground. U.S. Pat. No. 5,234,225 issued on Aug. 10, 1993 to Winfred E. Yaple, U.S. Pat. No. 5,118,126 issued Jun. 2, 1992 also to Winfred E. Yaple, U.S. Pat. No. 5,100,164 issued on Mar. 31, 1992 issued to Yukio Miyamaru and U.S. Pat. No. 4,223,906 issued Sep. 23, 1980 to Peter Gratza disclose powered lift stands. These stands require pistons or actuators that are driven from a retracted position to an extended position. While they all provide a platform that supports the motorcycle in an upright position they are powered up and down to support the motorcycle.

Other patents have issued on a motorcycle stand that requires the user to drive the motorcycle forward or backward onto the stand. U.S. Pat. No. 5,623,855 issued Apr. 29, 1997 issued to Vernon H. Miles and U.S. Pat. No. 6,742,798 issued Jun. 1, 2004 to Franz Berkmann discloses a motorcycle parking stand where a user extends the kick stand and then places the motorcycle in reverse where they drive the motorcycle onto the stand before dismounting. While this leaves the motorcycle in an upright orientation in some situations backing the motorcycle against a raised curb would make the kickstand useless.

U.S. Pat. No. 2,791,441 issued May 7, 1957 to J. Phillips, U.S. Pat. No. 5,388,848 issued Feb. 14, 1995 to Leroy F. Silva et al., and U.S. Pat. No. 7,303,204 issued Dec. 4, 2007 to Haruhito Takahashi each disclose kickstands with legs that extend from both sides of the kickstand. In these three patents the kickstand is manually extended and the motorcycle is allowed to lean slightly too either side or the rider extends the kickstand and then further extends one or both sides to match each side to the topography of the ground thus leaving the motorcycle in an approximate upright position. These kickstands also retain the kickstand in an extended orientation by placing the kickstand in an over-center orientation to lock the kickstand in an extended orientation. While these patents are for two legged kickstands they require the user to move the motorcycle to retract the kickstand.

What is needed is a simple motorcycle parking kickstand that is manually extended and does not require the user to move the motorcycle to support the motorcycle on the kickstand. The proposed motorcycle air suspension parking stand provides this solution with a parking kickstand that is ideally configured for motorcycles with air suspension.

### BRIEF SUMMARY OF THE INVENTION

It is an object of the motorcycle air suspension parking stand for the parking stand to be mounted on motorcycle having air fillable suspension system. The air suspension system allows the ground clearance of the frame of the motorcycle to be raised or lowered based upon the amount of pressure in the air suspension system. The stand is rotated under the motorcycle when the suspension is at a high level of pressure. As the pressure is vented the frame of the motorcycle lowers onto the extended parking stand to support the motorcycle. When the rider wants to retract the stand they simply increase the pressure in the air suspension, and as the frame of the motorcycle rises a spring retracts the parking stand.

It is an object of the motorcycle air suspension parking stand for the stand to support the motorcycle without requiring the user to roll the motorcycle forward or backward onto the stand when they are parking the motorcycle or driving off. This provides the advantage of eliminating the need for a rider to determine the rolling distance when they park against a curb or other object. If further eliminates the forward or backward gravity roll as the motorcycle moves over the elevated center of a raised stand.

It is another object of the motorcycle air suspension parking stand to provide a stand that exists essentially. The existence of the stand within the frame of a motorcycle does not alter the ground clearance or drag on brush or street debris.

It is another object of the motorcycle air suspension parking stand to provide a stand that does not lean the motorcycle to one side or the other while it is extended. On hot days the asphalt ground gets soft and the point contact of a side kick stand allows a side mounted stand to sink. In some cases a leaning motorcycle will tip over causing damage to the motorcycle.

It is still another object of the motorcycle parking stand to be installed onto a motorcycle with that does not have air suspension. In this configuration a user rotates the kickstand and activates an air cylinder that pushed the kick stand onto the ground the support the motorcycle and allows the rider to dismount leaving both wheels and the extended kickstand in contact with the ground. When the rider wants to retract the kickstand they vent the pressure from the air cylinder and once the kickstand is raised off the ground it rotates back under the frame of the motorcycle.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A shows a top view of the parking stand configured for use on a motorcycle with air suspension using bolts to connect to the frame.

FIG. 1B shows a top view of the parking stand configured for use on a motorcycle with air suspension using U clamps to bolt to the frame.

FIG. 2 shows a motorcycle with air suspension where the kick stand is retracted and the air suspension is pressurized.

FIG. 3 shows a motorcycle with air suspension where the kick stand is retracted and the air suspension is pressurized.

FIG. 4 shows a motorcycle with air suspension where the kick stand is extended and the air suspension is vented.

FIG. 5A shows a top view of the parking stand configured for use on a Softtail motorcycle with air suspension using bolts to connect to the frame.

FIG. 5B shows a top view of the parking stand configured for use on a Softtail motorcycle with air suspension using U clamps to bolt to the frame.

FIG. 5C shows a side view of the parking stand.

FIG. 6A shows a top view of the parking stand configured for use on a Road King motorcycle with air suspension using bolts to connect to the frame.

FIG. 6B shows a top view of the parking stand configured for use on a Road King motorcycle with air suspension using U clamps to bolt to the frame.

FIG. 7 shows a top view of the parking stand configured for use on stock motorcycles.

FIG. 8 shows a side view of the parking stand configured for use on stock motorcycles where the kick stand is retracted.

FIG. 9 shows a side view of the parking stand configured for use on stock motorcycles where the kick stand is extended.

### DETAILED DESCRIPTION

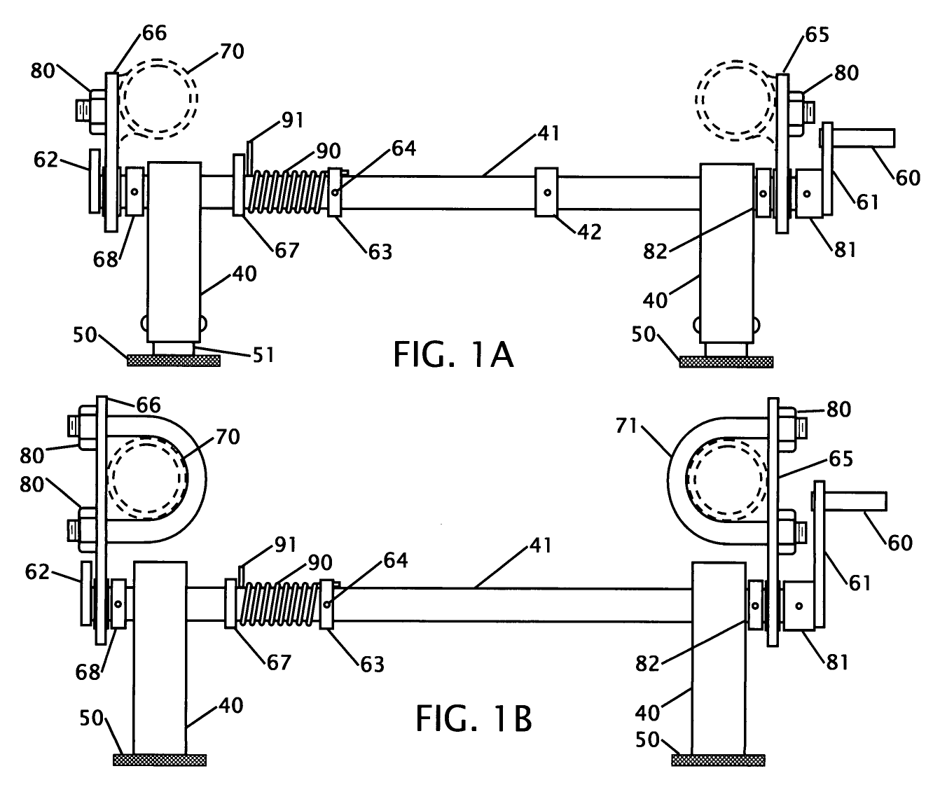

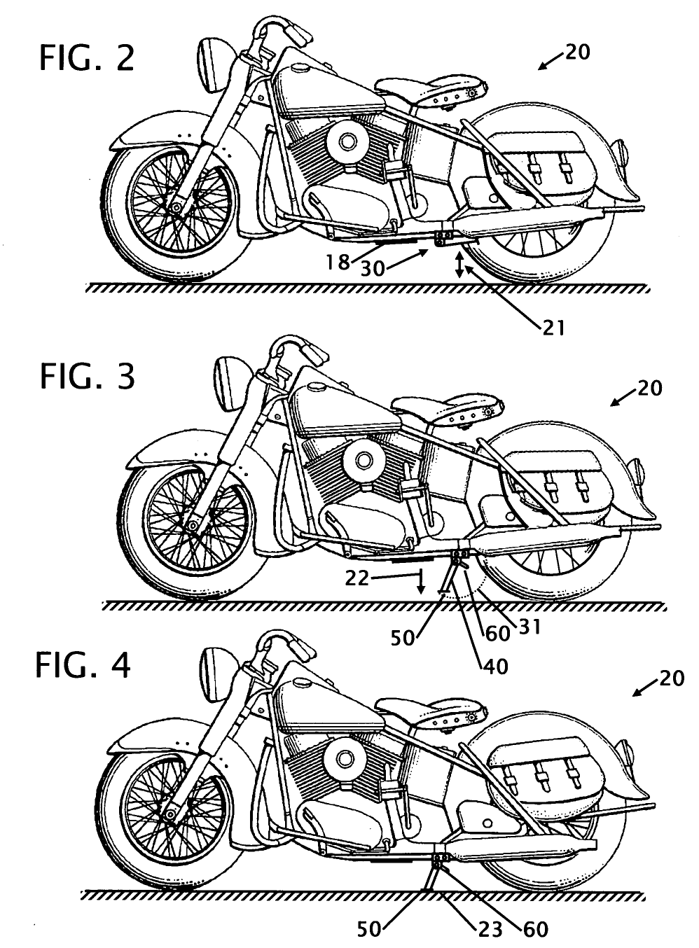

FIGS. 1A and 1B show a top view of the parking stand configured for use on a motorcycle with air suspension In FIG. 1A the kickstand is bolted to the frame with bolts 80 while in FIG. 1B the kickstand is bolted to the frame with U bolts 71. A motorcycle with air suspension is ideally suited for the kickstand that is disclosed in this application because the amount of air in the suspension system is directly related to the height of the motorcycle frame to the ground. Images of the motorcycle and the related ground clearance are shown and described in more detail with FIGS. 2-4. In this figure the components and the structure is shown and described because in FIGS. 2-4 only limited portions of the kickstand are visible.

The kickstand mounts to the frame 70 of an existing motorcycle. The frame tube 70 is used to provide a solid mounting to support the kickstand and the motorcycle. The kickstand mounts to the frame tube(s) 70 with a bolts 80 that hold the exhaust system onto the frame 65, 66 of the motorcycle. The plates 65 and 66 extend from the frame tubes 70 to a central support tube 41. Legs 40 are fixedly secured to the support tube 41. The legs 40 have foot pads 50 that support the motorcycle when they are properly engaged. The height of the foot pads 50 is adjustable to accommodate the heights of the frame from the ground. The adjustment is by sliding the extension tube 51 within the leg 40. A side view of this adjustment is shown and described in more detail in FIG. 9

The support tube 41 is pivotally mounted to the plates 65 and 66. On one end of the support tube 41 an outer plate 61 is fixedly secured, by welding or the like, and this outer plate 61 has an arm 60 that extends out the end of the plate. The arm 60 allows a rider to press the arm with their foot to rotate the support tube 41. A torsion spring 90 is secured to the support tube 41 to rotate the support tube 41 to maintain the legs 40 and the foot pads 50 in a retracted position when they are not engaged on the ground. An arm 91 on the end of the torsion spring 90 provides the resistance to bias the kickstand in the retracted position. Collars 63 and 67 maintain the position of the torsion spring 90. Item 42 is a leg stopper to prevent over rotation of the legs. A set screw 64 is used to locate and retain the collar(s) on the support tube 41. Collars 68, 81 and 82 maintain the position of the support tube 41. End plate 62 locks the end of the support tube 41.

In operation the torsion spring 90 maintains the kickstand in a retracted position. When the use is ready to part their motorcycle they press down on arm 60 that rotates the legs 40 and pads 50 under the motorcycle. The rider then vents air pressure from the suspension system and the motorcycle lowers onto the foot pads 50. The rider can then dismount the motorcycle and the legs are maintained in position from the weight of the motorcycle. Both wheels and both foot pads 50 are in contact with the ground to maintain the motorcycle in an essentially upright orientation. When the rider wants to retract the kickstand they simply increase the air pressure in the suspension system. As the pressure increases the frame of the motorcycle raises until the torsion spring retracts the foot pads 50 off the ground. With this understanding refer to FIGS. 2-4.

FIGS. 2-4 show a motorcycle 20 with air suspension at various stages of using the kick stand. From FIG. 2 the kickstand 30 is retracted and the air suspension 18 is pressurized. The height 21 of the frame of the motorcycle 20 above the ground allows the kickstand to be extended and retracted without making contact with the ground.

In FIG. 3 the kickstand 30 is extended and the air suspension is pressurized. The user presses down on arm 60 to rotate the leg 40 and the foot pad 50. Arc 31 shows that there is clearance for the kickstand to be rotated under the motorcycle 20. As the air pressure is vented from the suspension system the motorcycle 20 will lower 22. The user must maintain the arm 60 in the downward position while the air is being vented. In FIG. 4 the kickstand 30 is extended and the air suspension is vented to allow the foot pad 50 make contact with the ground 23.

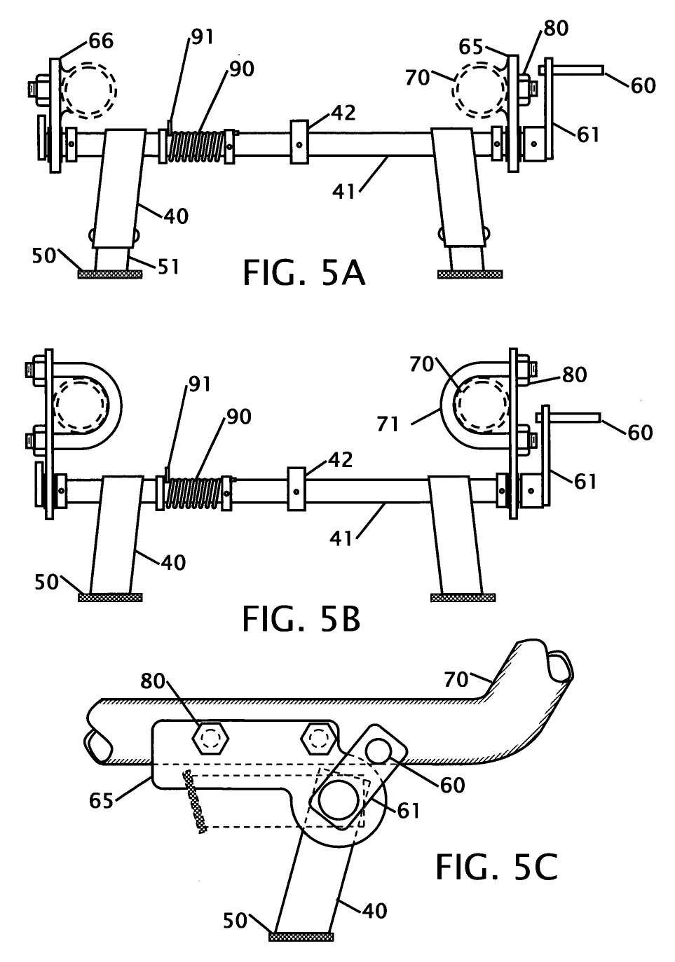

Depending upon the configuration of the motorcycle, the kickstand will need to be modified to accommodate the frame. FIG. 5A and FIG. 5B shows a top view of the parking stand configured for use on a Softtail motorcycle with air suspension. In FIG. 5A the kickstand is bolted to the frame while in FIG. 5B the kickstand is secured to the frame with U bolts. This configuration is similar to the kickstand shown and described in FIG. 1A and FIG. 1B with the most notable difference being the angled orientation of the legs 40. This angled configuration allows the kickstand to provide a broader stance and further reduces the potential for the motorcycle to fall over. The kickstand mounts to plates 65 and 66 that extend from the frame tubes 70 of an existing motorcycle. The side plates 65 and 66 extend from the frame tubes 70 to a central support tube 41. Legs 40 are fixedly secured to the support tube 41 at an angle. The legs 40 have foot pads 50 that support the motorcycle when they are properly engaged. The height of the foot pads 50 is adjustable to accommodate the heights of the frame from the ground. The adjustment is by sliding the extension tube 51 within the leg 40.

The outer plate 61 has an arm 60 that extends out the end of the plate. The arm 60 allows a rider to press the arm with their foot to rotate the support tube 41. A torsion spring 90 is secured to the support tube 41 to rotate the support tube 41 to maintain the legs 40 and the foot pads 50 in a retracted position when they are not engaged on the ground. An arm 91 on the end of the torsion spring 90 provides the resistance to bias the kickstand in the retracted position. Item 42 (and others shown but not numbered) maintains the position of rotated leg and prevents over rotation of the leg from torsion spring 90.

FIG. 5C shows a side view of the parking stand. The plate 65 is shown bolted to the tubular frame 70 of the motorcycle with bolts 80 The arm 60 is connected to the outer plate 61 that is the connected to the central shaft 41. The leg 40 with foot pad 50 is shown in a lowered and retracted (dashed) mode.

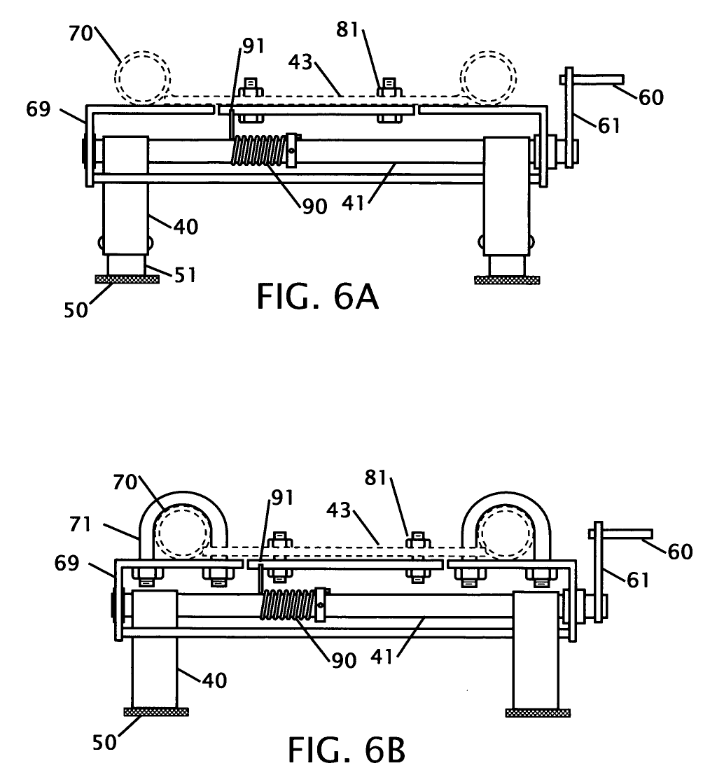

FIGS. 6A and 6B shows a top view of the parking stand configured for use on a Road King motorcycle with air suspension. In FIG. 6A the kickstand is bolted to the frame while in FIG. 6B the kickstand is secured to the frame with U bolts. The notable difference in this mounting is with the frame tube 70 existing is a different side plates 69 are bent to accommodate both the ends of the support tube 41. Legs 40 are fixedly secured to the support tube 41. The legs 40 have foot pads 50 that support the motorcycle when they are properly engaged. The height of the foot pads 50 is adjustable to accommodate the heights of the frame from the ground. The adjustment is by sliding the extension tube 51 within the leg 40.

The outer plate 61 has an arm 60 that extends out the end of the plate. The arm 60 allows a rider to press the arm with their foot to rotate the support tube 41. A torsion spring 90 is secured to the support tube 41 to rotate the support tube 41 to maintain the legs 40 and the foot pads 50 in a retracted position when they are not engaged on the ground. An arm 91 on the end of the torsion spring 90 provides the resistance to bias the kickstand in the retracted position. Collars 42 maintain the position of the torsion spring 90 and the support tube 41. Road King motorcycles have a plate 43 that is located on the frame. The plate make an ideal mounting surface for bolting 81 the kickstand to the motorcycle

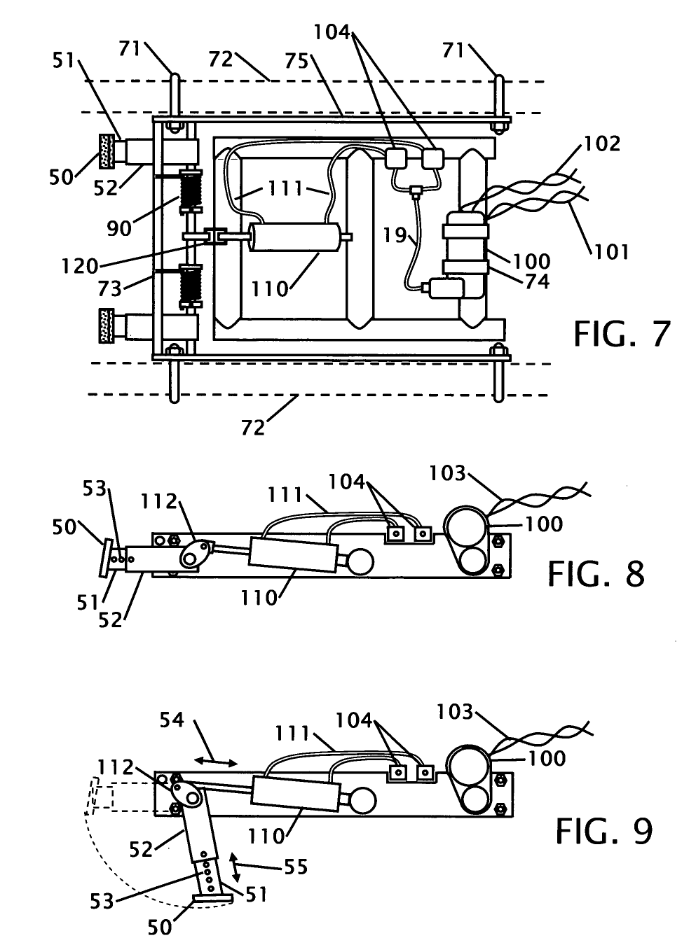

FIG. 7 shows a top view of the parking stand configured for use on stock motorcycles that does not have air suspension. This configuration uses its own air pump to extend the kickstand and when the air is vented the kickstand is retracted. For the purposes of illustration the motorcycle has side frame tubes 72 where the kickstand is mounted with U clamps 71 or similar mounting hardware. Side plates or bars 75 create structural support for the kickstand. The kickstand uses an air pump 100 that is secured to the frame with clamps 74. The air pump is supplied with power connection 101 and directional control 102 that increases or decreases the air pressure. The compressor 100 has one or more air tubes 19 that connect to relay switched 104 that are then connected to tubes 111 that connect to an air cylinder 110 for moving the piston on the air cylinder 110 in either direction. Torsion spring(s) 90 maintains the kickstand legs 52 in a retracted position when there is no pressure in the air cylinder 110. An arm on the torsion spring pushes on a tube 73 to rotate the legs in a retracted position. Because of variations of the heights of motorcycle frames the legs 52 are adjustable by moving extension tube 51 within the leg 52. The foot pad(s) 50 are secured or welded to the bottom of the extension tube 51. A coupling 120 connects the air cylinder 110 to the legs to extend or retract the legs of the kickstand.

FIG. 8 shows a side view of the parking stand configured for use on stock motorcycles where the kick stand is retracted while FIG. 9 shows a side view of the parking stand configured for use on stock motorcycles where the kick stand is extended. When the air pump 100 is energized from the wiring 103 the relay switches or valves 104 will supply air pressure through hoses 111 to the air cylinder 110. From FIG. 8 the air cylinder 110 has the leg retracted whereas in FIG. 9 the air cylinder has the leg extended because the piston and shaft of the air cylinder 110 has moved 54 by pushing the arm 112 thereby rotating the leg 52. When the leg is rotated the foot pad 50 is in position for resting on the ground. In FIG. 9 the extension of the leg is visible where multiple holes 53 are shown in the side of the extension tube 51 with a single hole in the leg 52 for positioning 55 the extension tube 51 to accommodate the desirable length of the extension tube in the leg to match the height of the frame of the motorcycle with the ground.

Thus, specific embodiments of a motorcycle air suspension parking stand have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A bi-legged extendable motorcycle kickstand comprising:
a bi-legged kickstand;
a spring that creates force to maintain the bi-legged kickstand in a retracted orientation;
a user operable lever that rotates said bi-legged kickstand to overcome said force from said spring from said retracted orientation to an extended orientation wherein;
when said bi-legged kickstand is extended and air pressure from a air suspension system on a motorcycle is exhausted said bi-legged kickstand supports at least a portion of said motorcycle; and
when said air pressure from said air suspension system is increased said spring force retracts said bi-legged kickstand.

2. The bi-legged extendable motorcycle kickstand according to claim 1 that further includes mounting hardware for mounting the kickstand on a frame of a motorcycle.

3. The bi-legged extendable motorcycle kickstand according to claim 2 wherein said mounting hardware is C clamps, U clamps and or bolts.

4. The bi-legged extendable motorcycle kickstand according to claim 1 that includes two legs to maintain the motorcycle in an essentially upright orientation when the motorcycle is supported on the said two legs.

5. The bi-legged extendable motorcycle kickstand according to claim 4 that further includes a footpad located on the end of the bi-legs.

6. The bi-legged extendable motorcycle kickstand according to claim 4 that further includes an adjustment mechanism on the legs to increase or decrease the length of the leg(s).

7. The bi-legged extendable motorcycle kickstand according to claim 1 wherein said spring is a torsion spring.

8. The bi-legged extendable motorcycle kickstand according to claim 1 wherein said bi-legged kickstand provides a wider supporting base for a motorcycle.

9. The bi-legged extendable motorcycle kickstand according to claim 1 wherein the legs are configured to stop over the rotational center of the legs to allows the weight of said motorcycle to maintain the legs in the rotated orientation.

10. A bi-legged extendable motorcycle kickstand comprising:
a bi-legged kickstand;
a spring that creates force to maintain the bi-legged kickstand in a retracted orientation;
an air cylinder that moves in a first direction to rotate the bi-legged kickstand to overcome said force from said spring from said retracted orientation to an extended orientation wherein;
when said bi-legged kickstand is extended air pressure maintains the bi-legged kickstand in an extended orientation to supports at least a portion of said motorcycle; and
when said air cylinder moves in a direction opposite of said first direction said spring force retracts said bi-legged kickstand.

11. The bi-legged extendable motorcycle kickstand according to claim 10 that further includes mounting hardware for mounting the kickstand on a frame of a motorcycle.

12. The bi-legged extendable motorcycle kickstand according to claim 11 wherein said mounting hardware is C clamps, U clamps and or bolts.

13. The bi-legged extendable motorcycle kickstand according to claim 10 that includes two legs to maintain the motorcycle in an essentially upright orientation when the motorcycle is supported on the said two legs.

14. The bi-legged extendable motorcycle kickstand according to claim 13 that further includes a footpad located on the end of the bi-legs.

15. The bi-legged extendable motorcycle kickstand according to claim 13 that further includes an adjustment mechanism on the legs to increase or decrease the length of the leg(s).

16. The bi-legged extendable motorcycle kickstand according to claim 10 wherein said spring is a torsion spring.

17. The bi-legged extendable motorcycle kickstand according to claim 10 wherein said bi-legged kickstand provides a wider supporting base for a motorcycle.

18. The bi-legged extendable motorcycle kickstand according to claim 10 wherein the legs are configured to stop over the rotational center of the legs to allows the weight of said motorcycle to maintain the legs in the rotated orientation.

19. The bi-legged extendable motorcycle kickstand according to claim 10 that further includes an air compressor that supplies air to the air cylinder.

20. The bi-legged extendable motorcycle kickstand according to claim 19 that further includes at least one valve to supply air pressure to at least one side of the air cylinder.
